(19) United States
(12) Patent Application Publication
(10) Pub. No.: US 2018/0173236 A1
(43) Pub. Date: Jun. 21, 2018

(54) VEHICLE CONTROL SYSTEM, VEHICLE CONTROL METHOD, AND VEHICLE CONTROL PROGRAM

(71) Applicant: HONDA MOTOR CO., LTD., Tokyo (JP)

(72) Inventors: Katsuya Yashiro, Utsunomiya-shi (JP); Toshiyuki Kaji, Saitama-shi (JP); Toru Kokaki, Utsunomiya-shi (JP); Masanori Takeda, Tokyo (JP); Hiroshi Oguro, Utsunomiya-shi (JP)

(21) Appl. No.: 15/830,101

(22) Filed: Dec. 4, 2017

(30) Foreign Application Priority Data
Dec. 20, 2016 (JP) 2016-247072

(51) Int. Cl. G05D 1/02

(52) U.S. Cl. CPC G05D 1/0212

(57) ABSTRACT

A vehicle control system includes: a recognition part that recognizes a state of a peripheral object; an approach determination part that determines, based on the behavior of a rearward vehicle recognized by the recognition part, approach of the rearward vehicle; and an action plan generation part that displaces a vehicle in an intersect direction which intersects with a travel route within a travel road when the approach determination part determines that there is an approach and when the recognition part recognizes an object in front of the vehicle.

### CROSS-REFERENCE TO RELATED APPLICATION

Priority is claimed on Japanese Patent Application No. 2016-247072, filed on Dec. 20, 2016, the contents of which are incorporated herein by reference.

### BACKGROUND

### Field of the Invention

The present invention relates to a vehicle control system, a vehicle control method, and a vehicle control program.

### Background

In the related art, research and development on automated driving techniques of a vehicle have been conducted. Automated driving is a technique in which at least one of acceleration/deceleration and steering of a vehicle is automatically controlled to allow the vehicle to travel. In relation to this, a drive assist apparatus has been proposed that aims at detecting a tailgating behavior and preventing an accident or trouble with a rearward vehicle. The drive assist apparatus determines peripheral circumstances from an output of a navigation device, a road information collection device, and a camera, determines a state of a vehicle from an output of a speed sensor, an acceleration sensor, a camera, a lighting system, and a vehicle control system, and determines a state of another vehicle from an output of a camera, an inter-vehicle communication device, and a radar.

The drive assist apparatus calculates a tailgating risk degree from the determined peripheral circumstances, the determined state of a vehicle, and the determined state of another vehicle and performs a notification control and an operation control based on a calculation result (for example, refer to Japanese Patent Application, Publication No. 2006-205773A).

### SUMMARY

However, in the related art, frontward circumstances of a vehicle are not sufficiently considered in an operation control with respect to tailgating from a rearward vehicle.

An object of an aspect of the present invention is to provide a vehicle control system, a vehicle control method, and a vehicle control program capable of causing a rearward vehicle to understand frontward circumstances and inhibiting tailgating.

(1) A vehicle control system according to an aspect of the present invention includes: a recognition part that recognizes a state of a peripheral object; an approach determination part that determines, based on the behavior of a rearward vehicle recognized by the recognition part, approach of the rearward vehicle; and an action plan generation part that displaces a vehicle in an intersect direction which intersects with a travel route within a travel road when the approach determination part determines that there is an approach and when the recognition part recognizes an object in front of the vehicle.

(2) In the above vehicle control system, the action plan generation part may displace the vehicle in a direction in which the object is visually recognized from a driver seat of the rearward vehicle.

(3) In the above vehicle control system, the recognition part may determine approach of the rearward vehicle based on a travel speed when the rearward vehicle passes through a tollbooth gate.

(4) In the above vehicle control system, the action plan generation part may not displace the vehicle when a distance from an end of a travel road to an end of the vehicle at a position after displacement of the vehicle at which the object is visually recognized is smaller than a predetermined distance.

(5) In the above vehicle control system, the action plan generation part may displace the vehicle in an opposite direction to an arrangement direction of a driver seat of the rearward vehicle.

(6) In the above vehicle control system, the object may be a predetermined region of a frontward vehicle that precedes the vehicle.

(7) In the above vehicle control system, the recognition part may determine a class of the frontward vehicle or a class of the rearward vehicle, and the action plan generation part may determine whether or not the displacement is required based on the class.

(8) Another aspect of the present invention is a vehicle control method, by way of a computer, including: recognizing a state of a peripheral object; determining, based on a recognized behavior of a rearward vehicle, approach of the rearward vehicle; and displacing a vehicle in an intersect direction that intersects with a travel route within a travel road when it is determined that there is an approach and when an object is recognized in front of the vehicle.

(9) Still another aspect of the present invention is a non-transitory computer-readable recording medium including a vehicle control program that causes a computer to: recognize a state of a peripheral object; determine, based on a recognized behavior of a rearward vehicle, approach of the rearward vehicle; and displace a vehicle in an intersect direction that intersects with a travel route within a travel road when it is determined that there is an approach and when an object is recognized in front of the vehicle.

According to the configurations (1), (8), and (9) described above, the vehicle is displaced in a direction that intersects with the travel road, and therefore, it is possible to cause a driver of the rearward vehicle to understand frontward circumstances of the vehicle and thereby to inhibit tailgating driving of the rearward vehicle.

According to the configuration (2) described above, a driver of the rearward vehicle can find the object in front of the vehicle by the displacement of the vehicle. Therefore, it is possible to reliably cause the driver of the rearward vehicle to understand a situation in which the vehicle travels at a lower speed than the rearward vehicle and to cause the driver of the rearward vehicle to stop the abnormal approach to the vehicle.

According to the configuration (3) described above, it is possible to further reliably determine the approach of the rearward vehicle by a simple process. This is because, in general, a rearward vehicle having a higher travel speed when passing through a tollbooth has a higher possibility of approaching the vehicle.

According to the configuration (4) described above, when approach of the vehicle after displacement to a travel lane line is anticipated depending on a positional relationship between the object in front of the vehicle and the driver seat of the rearward vehicle, the vehicle is not displaced. Thereby, approach to an end of the travel road is avoided, and therefore, it is possible to maintain travel safety.

According to the configuration (5) described above, the displacement amount of the vehicle is smaller than a case in which the vehicle is displaced in the same direction as the arrangement direction of the driver seat of the rearward vehicle. Therefore, travel safety is maintained as far as possible, and the load to a drive mechanism due to the change of a trajectory can be made small.

According to the configuration (6) described above, the driver of the rearward vehicle can find the predetermined region of the frontward vehicle by the displacement of the vehicle. It is possible to cause the driver of the rearward vehicle to understand the travel state of the frontward vehicle as the situation in which the vehicle travels at a lower speed than the rearward vehicle, and therefore, it is possible to cause the driver of the rearward vehicle to stop the abnormal approach to the vehicle.

According to the configuration (7) described above, it is possible to avoid performing unnecessary displacement of the vehicle when the frontward vehicle can be visually seen from the rearward vehicle depending on the class of the frontward vehicle or the rearward vehicle.

### BRIEF DESCRIPTION OF THE DRAWINGS

FIG. 1 is a configuration view of a vehicle system that includes an automated driving control unit according to an embodiment of the present invention.

FIG. 2 is a view showing a state in which a relative position and an attitude of a vehicle with respect to a travel lane are recognized by a vehicle position recognition unit according to the embodiment of the present invention.

FIG. 3 is a view showing a state in which a target trajectory is generated based on a recommended lane.

FIG. 4 is a view showing an example of a traffic situation that produces tailgating.

FIG. 5 is a view showing an example of an approach determination method according to the embodiment of the present invention.

FIG. 6 is a view showing an example of an offset according to the embodiment of the present invention.

FIG. 7 is a view showing another example of an offset according to the embodiment of the present invention.

FIG. 8 is a view showing an example of vehicle tail parts of a vehicle and a frontward vehicle.

FIG. 9 is a view showing another example of vehicle tail parts of a vehicle and a frontward vehicle.

FIG. 10 is a flowchart showing a vehicle control process according to the embodiment of the present invention.

### DESCRIPTION OF THE EMBODIMENTS

Hereinafter, a vehicle control system, a vehicle control method, and a vehicle control program according to an embodiment of the present invention will be described with reference to the drawings. In the following description, unless otherwise specified, a “frontward direction” indicates a direction of a travel route of a vehicle. A “rearward direction” indicates an opposite direction of the “frontward direction”. A “leftward direction” indicates a leftward direction with respect to the “frontward direction”. A “rightward direction” indicates a rightward direction with respect to the “frontward direction”. A “lateral direction” is a collective term of the “rightward direction” and the “leftward direction”.

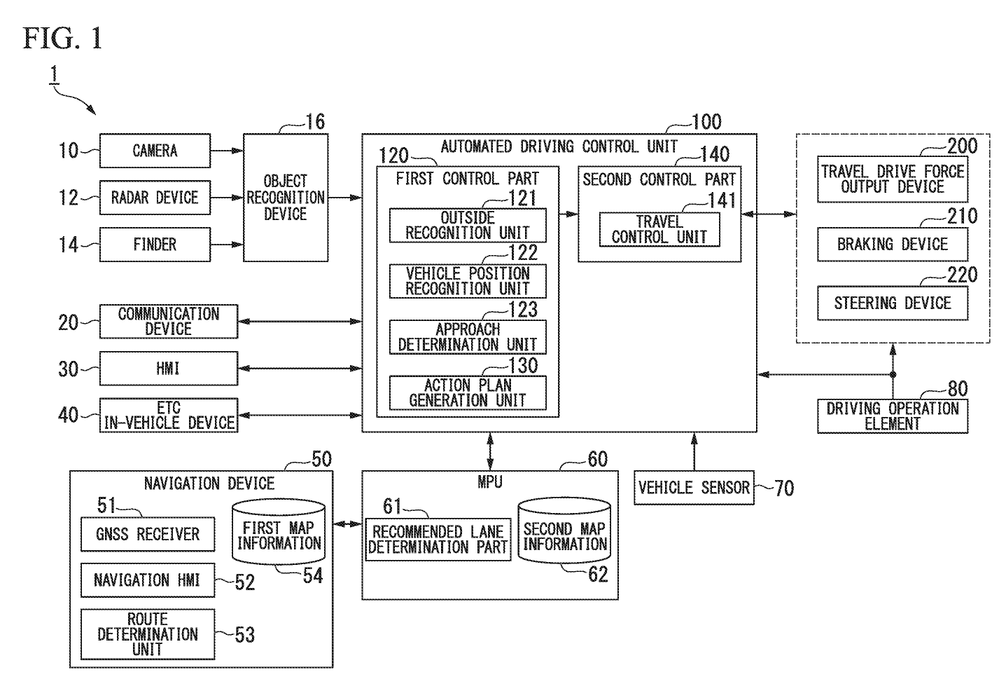

FIG. 1 is a configuration view of a vehicle system 1 that includes an automated driving control unit 100. A vehicle on which the vehicle system 1 is provided is, for example, a vehicle having two wheels, three wheels, four wheels, or the like. A drive source of the vehicle on which the vehicle system 1 is provided is an internal combustion engine such as a diesel engine and a gasoline engine, an electric motor, or the combination of the internal combustion engine and the electric motor. The electric motor is operated by using generated electric power by a generator connected to the internal combustion engine or discharged electric power of a secondary battery or a fuel cell.

The vehicle system 1 includes, for example, a camera 10, a radar device 12, a finder 14, an object recognition device 16, a communication device 20, a HMI (Human Machine Interface) 30, an ETC (Electronic Toll Collection system) in-vehicle device 40, a navigation device 50, a MPU (Micro-Processing Unit) 60, a vehicle sensor 70, a driving operation element 80, the automated driving control unit 100, a travel drive force output device 200, a braking device 210, and a steering device 220. These devices and equipment are mutually connected by a multiplex communication line such as a CAN (Controller Area Network) communication line, a serial communication line, a wireless communication network, and the like. The configuration shown in FIG. 1 is merely an example; part of the configuration may be omitted, and another configuration may be further added. A “vehicle control system” includes at least the automated driving control unit 100. The “vehicle control system” may include part of or all of the configurations other than the automated driving control unit 100 of the vehicle system 1.

The camera 10 is, for example, a digital camera that uses a solid-state imaging element such as a CCD (Charge-Coupled Device) or a CMOS (Complementary Metal Oxide Semiconductor). One or more cameras 10 are attached to an arbitrary part of the vehicle (hereinafter, referred to as a vehicle M) on which the vehicle system 1 is provided. When imaging the frontward direction, the camera 10 is attached to an upper part of a front window shield, a rear surface of a room mirror, and the like. For example, the camera 10 periodically and repeatedly captures an image of the vicinity of the vehicle M. The camera 10 may be a stereo camera.

The radar device 12 radiates radio waves such as millimeter waves to the vicinity of the vehicle M and detects the radio waves (reflected waves) reflected by an object to detect at least a position (distance and azimuth) of the object. One or more radar devices 12 are attached to an arbitrary part of the vehicle M. The radar device 12 may detect the position and the speed of the object by a FM-CW (Frequency-Modulated Continuous Wave) method.

The finder 14 is a LIDAR (Light Detection and Ranging, or Laser Imaging Detection and Ranging) that measures scattered light with respect to irradiation light and that detects a distance to a target. One or more finders 14 are attached to an arbitrary part of the vehicle M.

The object recognition device 16 performs a sensor fusion process with respect to a detection result by part of or all of the camera 10, the radar device 12, and the finder 14 and recognizes the position, category, speed, and the like of the object. The object recognition device 16 outputs the recognition result to the automated driving control unit 100. The object recognition device 16 may output part of information that is input from the camera 10, the radar device 12, and the finder 14 as is to the automated driving control unit 100.

The communication device 20 communicates with another vehicle that is present in the vicinity of the vehicle M, for example, by using a cellular network, a Wi-Fi network, Bluetooth (registered trademark), DSRC (Dedicated Short-Range Communication), and the like or communicates with a variety of server apparatuses and other apparatuses via a wireless base station.

The HMI 30 presents a variety of information to an occupant of the vehicle M and accepts an input operation by the occupant. The HMI 30 includes a variety of display devices, a speaker, a buzzer, a touch panel, a switch, a key, and the like.

The ETC in-vehicle device 40 includes an attachment part to which an ETC card is attached and a wireless communication part that communicates with an ETC roadside device that is provided on a gate of a toll road. The wireless communication part may be shared with the communication device 20. The ETC in-vehicle device 40 communicates with the ETC roadside device and thereby exchanges information of an entrance tollbooth, an exit tollbooth, and the like. The ETC roadside device determines a billing amount to an occupant of the vehicle M based on the information and proceeds with a billing process. In addition, the ETC in-vehicle device 40 receives a variety of information from the ETC roadside device.

The navigation device 50 includes, for example, a GNSS (Global Navigation Satellite System) receiver 51, a navigation HMI 52, and a route determination unit 53. The navigation device 50 holds first map information 54 in a storage device such as a HDD (Hard Disk Drive) and a flash memory. The GNSS receiver identifies the position of the vehicle M based on a signal that is received from the GNSS satellite. The position of the vehicle M may be identified or supplemented by an INS (Inertial Navigation System) that utilizes an output of the vehicle sensor 70. The navigation HMI 52 includes a display device, a speaker, a touch panel, a key, and the like. Part of or all of the navigation HMI 52 may be shared with the HMI 30 described above. For example, the route determination unit 53 determines, with reference to the first map information 54, a route from the position (or an input arbitrary position) of the vehicle M that is identified by the GNSS receiver 51 to a destination input by the occupant by using the navigation HMI 52.

The first map information 54 is, for example, information in which a road shape is described by a link indicating a road and a node that is connected by the link. The first map information 54 may include the curvature of a road, POI (Point Of Interest) information, and the like. The route determined by the route determination unit 53 is output to the MPU 60. The navigation device 50 may prepare a route guide using the navigation HMI 52 based on the route determined by the route determination unit 53.

The navigation device 50 may be realized by, for example, a function of a terminal apparatus such as a smartphone and a tablet terminal held by the user. The navigation device 50 may transmit a current position and a destination to a navigation server via the communication device 20 and may acquire a route which is returned from the navigation server.

The MPU 60 functions, for example, as a recommended lane determination part 61. The MPU 60 holds second map information 62 in a storage device such as a HDD and a flash memory. The recommended lane determination part 61 divides the route that is supplied from the navigation device 50 into a plurality of blocks (for example, divides at an interval of 100 [m] with respect to a vehicle travel direction) and determines a recommended lane for each block with reference to the second map information 62. The recommended lane determination part 61 determines, for example, which lane from the left the vehicle should travel on.

When a branching point, a merging point, or the like is present on the route, the recommended lane determination part 61 determines a recommended lane such that the vehicle M can travel on a reasonable route for proceeding to a branch destination.

The second map information 62 is map information having higher accuracy than the first map information 54. The second map information 62 includes, for example, information of the center of a lane, information of the boundary of a lane, or the like.

The second map information 62 may include road information, traffic regulation information, address information (address and zip code), facility information, phone number information, and the like. The road information includes information representing the class of a road such as a freeway, a toll road, a national road, or a prefectural road and information of the lane number of a road, the width of each lane, the gradient of a road, the position of a road (three-dimensional coordinate including the longitude, latitude, and height), the curvature of a curve of a lane, the position of merging and branching points of a lane, a sign provided on a road, and the like. The second map information 62 may be updated as needed by accessing another apparatus using the communication device 20.

The vehicle sensor 70 includes a vehicle speed sensor that detects the speed of the vehicle M, an acceleration sensor that detects acceleration, a yaw rate sensor that detects an angular speed around a vertical axis, an azimuth sensor that detects the direction of the vehicle M, and the like.

The driving operation element 80 includes, for example, an accelerator pedal, a brake pedal, a shift lever, a steering wheel, and other operation elements. A sensor that detects the amount of operation or the presence or absence of operation is attached to the driving operation element 80. A detection result of the sensor of the driving operation element 80 is output to one or both of the automated driving control unit 100, and the travel drive force output device 200, the braking device 210, and the steering device 220.

The automated driving control unit 100 includes, for example, a first control part 120 and a second control part 140. Each of the first control part 120 and the second control part 140 is realized by executing a program (software) by a processor such as a CPU (Central Processing Unit). Part of or all of functional parts of the first control part 120 and the second control part 140 described below may be realized by hardware such as a LSI (Large-Scale Integration), an ASIC (Application-Specific Integrated Circuit), and a FPGA (Field-Programmable Gate Array) or may be realized by the cooperation of software and hardware.

The first control part 120 includes, for example, an outside recognition unit 121 (recognition unit), a vehicle position recognition unit 122, an approach determination unit 123, and an action plan generation unit 130.

The outside recognition unit 121 recognizes a state of the position, speed, acceleration, and the like of a peripheral object of the vehicle M based on information input via the object recognition device 16 from the camera 10, the radar device 12, and the finder 14. The peripheral object includes, for example, a vehicle (hereinafter, referred to as a peripheral vehicle). The peripheral vehicle may include a frontward vehicle and a rearward vehicle. The frontward vehicle is a vehicle that travels at a frontward position of the vehicle M, specifically, immediately before the vehicle M. The rearward vehicle is a vehicle that travels at a rearward position of the vehicle M, specifically, immediately after the vehicle M. The position of a peripheral vehicle may be represented by a representative point such as a center of gravity or a corner of the peripheral vehicle or may be represented by a region described by the outline of the peripheral vehicle. The “state” of a peripheral vehicle may include the acceleration, jerk, or “action state” (for example, whether or not the peripheral vehicle is changing a lane, or whether or not the peripheral vehicle will change a lane) of the peripheral vehicle. The outside recognition unit 121 may recognize positions of a guardrail, a power pole, a parked vehicle, a pedestrian, and other objects. The outside recognition unit 121 may recognize, as the state of an object, the position, shape, and the like of the displayed object. The displayed object includes, for example, a variety of road signs, road markers, and the like. Examples of the road sign include a road partition line. For example, the road partition line or the like is a recognition target.

The outside recognition unit 121 may identify detection information that comes from each object based on the recognized position among detection information from a microphone (not shown), an illumination sensor (not shown), and other sensors. In this process, the outside recognition unit 121 identifies detection information from a rearward vehicle. For example, the outside recognition unit 121 detects, based on a temporal change of the brightness of light that comes from a light source (headlight) provided on a forefront part of the rearward vehicle, blinking of the light (headlight flashing).

The outside recognition unit 121 recognizes, from speech that is collected by the microphone by using a known sound source identification technique, a warning sound of which sound source direction is the direction of the forefront part of the rearward vehicle and which comes from the direction and detects the sound volume of the warning sound. The sound source of the warning sound is a honk (so-called horn, klaxon) arranged on the forefront part of the vehicle. The outside recognition unit 121 outputs the detection information indicating the state of each object to the approach determination unit 123 and the action plan generation unit 130.

The vehicle position recognition unit 122 recognizes, for example, the lane (travel lane) on which the vehicle M is travelling, and the relative position and attitude of the vehicle M with respect to the travel lane. The vehicle position recognition unit 122 recognizes the travel lane, for example, by comparing a pattern (for example, an arrangement of a solid line and a dashed line) of a road partition line that is obtained from the second map information 62 to a pattern of a road partition line in the vicinity of the vehicle M that is recognized from the image captured by the camera 10. The position of the vehicle M that is acquired from the navigation device 50 and the process result by the INS may be added to this recognition.

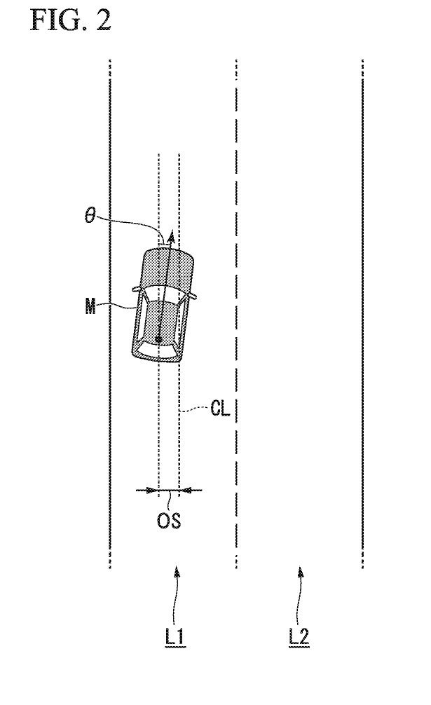

Then, the vehicle position recognition unit 122 recognizes, for example, the position and the attitude of the vehicle M with respect to the travel lane. FIG. 2 is a view showing a state in which the relative position and the attitude of the vehicle M with respect to a travel lane L are recognized by the vehicle position recognition unit 122. For example, the vehicle position recognition unit 122 recognizes, as the relative position and the attitude of the vehicle M with respect to the travel lane L, a gap OS of a reference point (for example, the center of gravity) of the vehicle M from a travel lane center CL and an angle θ formed by the travel direction of the vehicle M with respect to a line formed of the continued travel lane centers CL. Alternatively, the vehicle position recognition unit 122 may recognize, as the relative position of the vehicle M with respect to the travel lane, the position of the reference point of the vehicle M with respect to any of side end parts of the lane L and the like. The information of the relative position of the vehicle M that is recognized by the vehicle position recognition unit 122 is supplied to the recommended lane determination part 61 and the action plan generation unit 130.

With reference back to FIG. 1, the approach determination unit 123 determines whether or not a rearward vehicle is approaching the vehicle M based on the behavior of the rearward vehicle. The approach determination unit 123 uses, as the information representing the behavior of the rearward vehicle, detection information of the travel state (for example, a travel direction, acceleration, and deceleration) of the rearward vehicle and other detection information. The approach determination unit 123 outputs, to the action plan generation unit 130, approach information indicating whether or not a rearward vehicle is approaching. An example of an approach determination method of a rearward vehicle is described below.

The action plan generation unit 130 determines events that are sequentially performed in automated driving so as to travel on the recommended lane that is determined by the recommended lane determination part 61 and so as to be capable of responding to peripheral circumstances of the vehicle M recognized in the outside recognition unit 121. Examples of the event include a constant speed travel event of traveling on the same travel lane at a constant speed, a follow-up travel event of following up a frontward traveling vehicle, a lane-change event, a merging event, a branching event, an emergency stop event, and a changeover event for finishing automated driving and switching to manual driving. Further, an action for avoidance may be planned based on peripheral circumstances (presence of a peripheral vehicle or a pedestrian, lane narrowing due to a roadwork, and the like) of the vehicle M while performing the events.

The action plan generation unit 130 generates a target trajectory on which the vehicle M will travel. The target trajectory is represented as a time series in which points (trajectory points) to be arrived at by the vehicle M are sequentially arranged. The trajectory point is a point to be arrived at by the vehicle M at each of predetermined travel distances. Additionally, a target speed and target acceleration at a predetermined sampling interval (for example, about several hundred milliseconds) are generated as part of the target trajectory. The trajectory point may be a position, of each of predetermined sampling times, to be arrived at by the vehicle M at the sampling time. In this case, the information of the target speed and target acceleration is represented by the interval of trajectory points.

When the approach information that is input from the approach determination unit 123 indicates approach of a rearward vehicle, and when the detection information indicating that a frontward vehicle is traveling is input from the outside recognition unit 121, the action plan generation unit 130 generates a target trajectory such that the vehicle M is offset. The “offsetting” means displaces the position of the vehicle M, for example, in a direction that intersects with the travel route, that is, in a direction that is deviated in a lateral direction from the travel route direction. Thereby, a part, which is screened with respect to the rearward vehicle by the vehicle M, of more frontward environments than the vehicle M appears. For example, a vehicle body, an accessory, a load, and the like of the frontward vehicle are visually recognized by a driver of the rearward vehicle. Therefore, the driver of the rearward vehicle can understand frontward circumstances of the vehicle M. An example of offsetting of the vehicle M is described below.

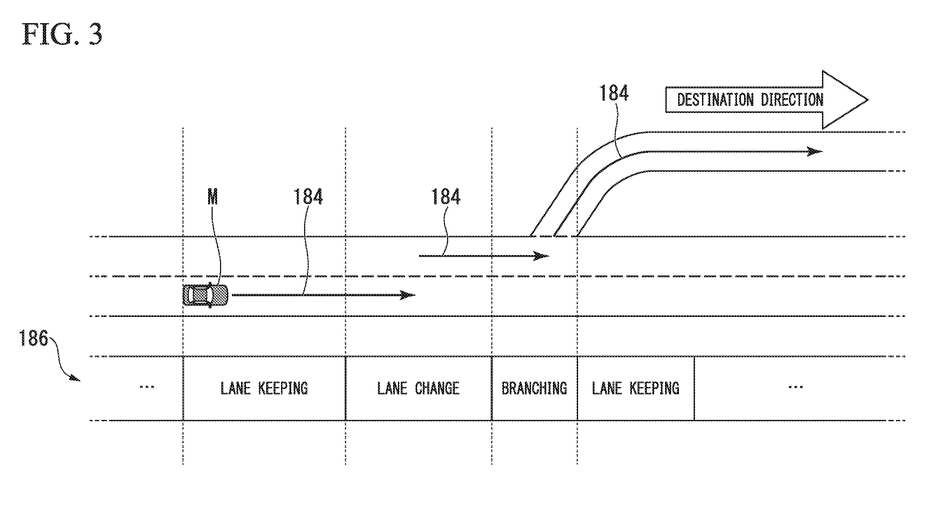

The recommended lane is set such that it is convenient to travel along a route to a destination. FIG. 3 is a view showing a state in which a target trajectory is generated based on a recommended lane. When arriving at a position (the position may be determined corresponding to the category of an event) by a predetermined distance before a position at which the recommended lane is switched, the action plan generation unit 130 starts a lane-change event, a branching event, a merging event, and the like. When it becomes necessary to avoid an obstacle while performing the events, an avoidance trajectory is generated as shown in the drawing.

The action plan generation unit 130 generates, for example, a plurality of candidates of the target trajectory and selects an optimum target trajectory at that time point based on a point of view of safety and efficiency. The action plan generation unit 130 may select the target trajectory generated such that the vehicle M is offset in priority to other target trajectories.

With reference back to FIG. 1, the second control part 140 includes a travel control unit 141. The travel control unit 141 controls the travel drive force output device 200, the braking device 210, and the steering device 220 such that the vehicle M passes through the target trajectory that is generated by the action plan generation unit 130 exactly at a scheduled time.

The travel drive force output device 200 outputs, to a drive wheel, a travel drive force (torque) by which the vehicle travels. The travel drive force output device 200 includes, for example, the combination of an internal combustion engine, an electric motor, a transmission, and the like and an ECU that controls the internal combustion engine, the electric motor, the transmission, and the like. The ECU controls the above configuration in accordance with information input from the travel control unit 141 or information input from the driving operation element 80.

The braking device 210 includes, for example, a brake caliper, a cylinder that transmits an oil pressure to the brake caliper, an electric motor that generates the oil pressure at the cylinder, and a brake ECU. The brake ECU controls the electric motor, in accordance with the information input from the travel control unit 141 or the information input from the driving operation element 80, to output a braking torque corresponding to a braking operation to each wheel. The braking device 210 may include, as a backup, a mechanism that transmits, to the cylinder via a master cylinder, an oil pressure generated by an operation of the brake pedal included in the driving operation element 80. The braking device 210 is not limited to the configuration described above and may be an electronically-controlled hydraulic braking device that controls an actuator in accordance with the information input from the travel control unit 141 and that transmits the oil pressure of the master cylinder to the cylinder.

The steering device 220 includes, for example, a steering ECU and an electric motor.

For example, the electric motor applies a force to a rack and pinion mechanism and changes the direction of a steering wheel. The steering ECU drives the electric motor and changes the direction of the steering wheel in accordance with the information input from the travel control unit 141 or the information input from the driving operation element 80.

(Example of a Traffic Situation that Produces Tailgating)

Next, an example of a traffic situation that produces tailgating is described. The tailgating is an action in which a rearward vehicle demonstrates to yield a road to a vehicle that travels more frontward than the rearward vehicle. A representative action of the tailgating is an action in which a rearward vehicle abnormally approaches to a vehicle that travels more frontward than the rearward vehicle or the like. The tailgating may cause a traffic accident and is therefore categorized as a kind of unsafe driving. The tailgating is also referred to as tailgating driving.

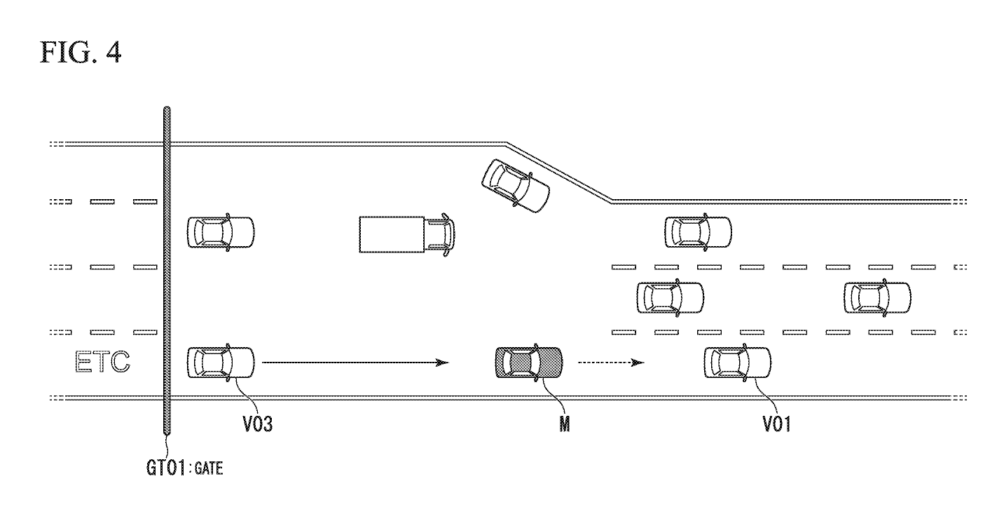

FIG. 4 is a view showing an example of a traffic situation that produces tailgating. FIG. 4 shows a traffic situation in a zone from an entrance gate GT01 of a toll road to a main road. A tollbooth at which a toll fare is collected with respect to a vehicle that enters the toll road is provided on the entrance gate GT01. In the example shown in FIG. 4, the entrance gate GT01 has a travel road having four lanes. One lane, which is at a right end when facing the travel direction, of the four lanes is an ETC exclusive lane on which an ETC gate is arranged. A vehicle which travels in the ETC exclusive lane can pass through the ETC gate without stopping and enter the toll road. In general, the speed limit of a toll road is higher than that of a general road, and therefore, a vehicle that passes through the ETC gate decelerates before passing and accelerates after passing. The speed when passing the ETC gate, the acceleration timing after passing, and the acceleration differ between vehicles. Therefore, the speed or acceleration of a rearward vehicle V03 after passing through the ETC gate may be higher than the speed or acceleration of the preceding vehicle M.

Further, in general, the number of lanes of the main road of the toll road is smaller than the number of lanes of the entrance gate GT01, and therefore, there is another lane that merges to a lane which directly continues to the main road. Therefore, it may not be possible for a vehicle that travels on the ETC exclusive lane that continues to the main road to change to another lane after passing through the entrance gate GT01. Accordingly, in such a situation, there is a high possibility that the low-speed vehicle M is subject to tailgating from the higher-speed rearward vehicle V03. Further, when the speed of a frontward vehicle V01 that precedes the vehicle M is similar to or less than the speed of the vehicle M, it may not be possible for the vehicle M to accelerate in order to maintain a predetermined inter-vehicle distance. This can be a cause that the vehicle M is subject to tailgating from the rearward vehicle V03. In order to collect a toll fare manually, a tollbooth is provided on a travel road other than the ETC exclusive lane among passages provided on the entrance gate GT01. The ETC exclusive lane may not be provided, or a lane line that segments the travel roads may not be displayed depending on the entrance gate. A vehicle that passes through the tollbooth temporarily stops or travels at an extremely low speed in order to pay the toll fare and then accelerates. Therefore, there is a high possibility that not only a vehicle that passes through the ETC exclusive lane but a vehicle that passes through the tollbooth is generally subject to tailgating from a rearward vehicle.

Examples of the traffic situation having a higher possibility that the vehicle M is subject to tailgating from the rearward vehicle V03 further include a case where the vehicle M is traveling at the tail end of a vehicle group in a traffic jam or in the vicinity of the vehicle group. In such a traffic situation, the speed of a frontward vehicle V01 is similar to or less than the speed of the vehicle M, but the speed of a rearward vehicle V03 is higher than the speed of the vehicle M. In a traffic jam, even when the road has a plurality of lanes, at a more frontward position than the vehicle M, frontward traveling vehicles traveling further frontward accumulate, and therefore, it may not be possible to change the travel lane.

The approach of a rearward vehicle to the vehicle is a representative action of tailgating. Therefore, the approach determination unit 123 determines whether or not a rearward vehicle is approaching the vehicle based on the behavior of the rearward vehicle. The behavior of the rearward vehicle is represented by detection information indicating the state of the rearward vehicle that is input from the outside recognition unit 121.

### (Approach Determination Method of Rearward Vehicle)

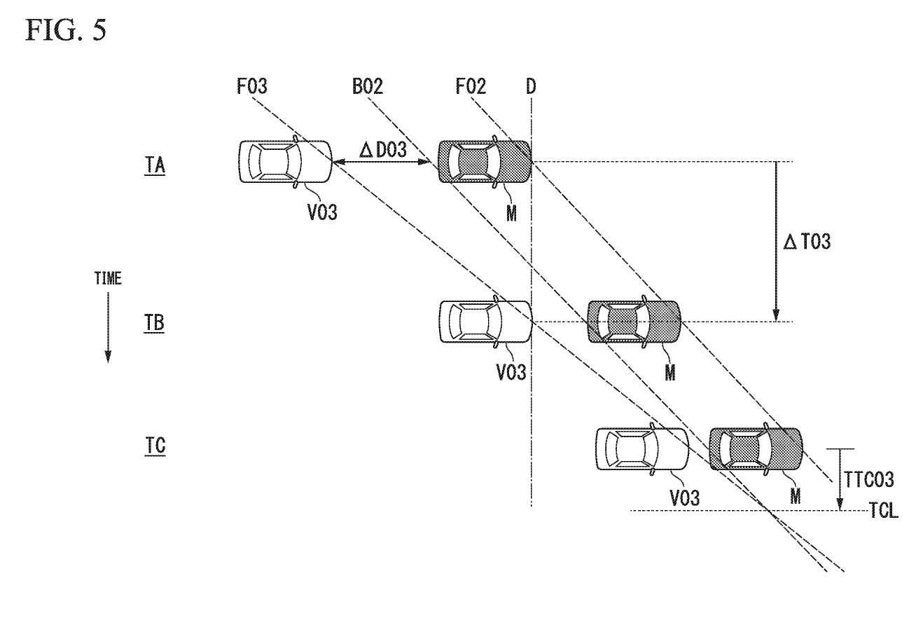

Next, an approach determination method of a rearward vehicle is described. FIG. 5 is a view showing an example (specifically, (a1) to (a3)) of an approach determination method according to the present embodiment. In an example shown in FIG. 5, the position in the vertical direction represents time, and a lower position represents a later time. The position in the horizontal direction represents a point on the travel lane, and the rightward direction represents the travel direction. Each of TA, TB, and TC represents a time.

A line F02 is a straight line that connects between positions of the vehicle head of the vehicle M at each time. A line F03 is a straight line that connects between positions of the vehicle head of the rearward vehicle V03 at each time. A line B02 is a straight line that connects between positions of the vehicle tail of the vehicle M at each time.

The approach determination unit 123 determines that the rearward vehicle V03 is approaching the vehicle M, for example, when a predetermined condition of conditions (a1) to (a7) described below is satisfied. The approach determination unit 123 may determine that the rearward vehicle V03 is approaching the vehicle M when a predetermined plurality of conditions of the conditions (a1) to (a7) is satisfied. In other cases, the approach determination unit 123 determines that the rearward vehicle V03 is not approaching the vehicle M. The approach determination unit 123 outputs approach information indicating whether or not the rearward vehicle V03 is approaching the vehicle M to the action plan generation unit 130.

(a1) When a Vehicle Head Time ΔT03 of the Rearward Vehicle V03 is Shorter than a Predetermined Threshold Value ΔT of the Vehicle Head Time

A vehicle head time ΔT03 corresponds to a time TB-TA which is from a time TA when the vehicle M that travels immediately before a rearward vehicle V03 passes through a predetermined point D to a time TB when the rearward vehicle V03 passes through the point D. A threshold value ΔT of the vehicle head time is, for example, 1 to 2 seconds. The approach determination unit 123 may adopt, for example, the position of a road marker on the travel lane of the vehicle M or the position of an object in the vicinity of the road marker as the point D. As the road marker, for example, a boundary line of a roadway travel zone and the like may be used. As the object, a variety of road signs, an ETC gate, a power pole, and the like may be used. The approach determination unit 123 detects the time TB when the rearward vehicle V03 passes through the point D from detection information that is input from the outside recognition unit 121. Further, the approach determination unit 123 detects a time point when a coordinate value of the travel direction of the vehicle M that is recognized by the vehicle position recognition unit 122 is equal to a coordinate value of the direction of the point D as the time TA when the vehicle M passes through the point D.

(a2) When an Inter-Vehicle Distance ΔD03 Between the Vehicle M and the Rearward Vehicle V03 is Shorter than a Predetermined Threshold Value ΔD of the Inter-Vehicle Distance

The inter-vehicle distance ΔD03 corresponds to a distance between the vehicle tail part of the vehicle M and the vehicle head part of the rearward vehicle V03. The approach determination unit 123 extracts the position of the vehicle head part of the rearward vehicle V03 using the vehicle tail part of the vehicle M as a standard, for example, from the detection information that is input from the outside recognition unit 121 and calculates an inter-vehicle distance ΔD03 based on the extracted position. The approach determination unit 123 may determine a distance that is obtained by multiplying the speed of the vehicle M by a predetermined proportionality coefficient as the threshold value ΔD. The proportionality coefficient is, for example, 0.2 to 0.3 km/h·s.

The approach determination unit 123 may determine that the rearward vehicle is approaching the vehicle when a continuation time ΔCT03 for which the state of (a1) or (a2) continues is equal to or more than a predetermined continuation time ΔCT.

(a3) When a Collision Prediction Time TTC03 (Time-to Collision) of the Rearward Vehicle V03 to the Vehicle M is Shorter than a Predetermined Threshold Value ΔTTC of the Collision Prediction Time

A collision prediction time TTC03 is a time from a time point (for example, time TC) to a estimation time TCL when it is estimated that the vehicle head part of the rearward vehicle V03 comes into contact with the vehicle tail part of the vehicle M. The approach determination unit 123 calculates, for example, a value that is obtained by dividing the inter-vehicle distance ΔD03 by an inter-vehicle speed ΔV03 as the collision prediction time TTC03. When calculating the inter-vehicle speed ΔV03, the approach determination unit 123 differentiates the collision prediction time TTC03 by time. The threshold value ΔTTC of the collision prediction time is, for example, 10 to 20 seconds.

(a4) When a Relative Acceleration AC03 of the Rearward Vehicle V03 Using the Vehicle M as a Standard is Higher than a Predetermined Threshold Value ΔAC of the Relative Acceleration

A relative acceleration AC03 is a difference of the acceleration of the vehicle M from the acceleration of the rearward vehicle V03.

When calculating the relative acceleration AC03, the approach determination unit 123 twice differentiates the inter-vehicle distance ΔD03 by time. The threshold value ΔAC of the relative acceleration is, for example, 2 to 3 km/h·s.

(a5) When a Passing Speed VE03 of an ETC Gate of the Rearward Vehicle V03 is Higher than a Predetermined Passing Speed ΔVE

A passing speed VE03 is a travel speed when the rearward vehicle V03 passes through an ETC gate.

The threshold value ΔT of the vehicle head time is, for example, 1 to 2 seconds. The approach determination unit 123 detects a time when the rearward vehicle V03 passes through the ETC gate from detection information that is input from the outside recognition unit 121 and calculates the speed of the rearward vehicle V03. The approach determination unit 123 determines the speed of the rearward vehicle V03 at the detected time as the passing speed VE03. An automated driving control unit that is provided on the rearward vehicle V03 may transmit the measured speed of the rearward vehicle V03 to other vehicles. In that case, the approach determination unit 123 may receive the information of the speed when the rearward vehicle V03 passes through the ETC gate.

The approach determination unit 123 may determine that the rearward vehicle is approaching the vehicle in the state of (a4) or (a5) and further when the inter-vehicle distance ΔD03 between the vehicle M and the rearward vehicle V03 is equal to or less than a predetermined threshold value ΔD′ of the inter-vehicle distance. The threshold value ΔD′ of the inter-vehicle distance is, for example, 50 to 100 m. When determining a passing time point of the ETC gate by the vehicle M or the rearward vehicle V03, the approach determination unit 123 may verify the position of the ETC gate indicated by the second map information 62 and the position of the vehicle M or the position of the rearward vehicle V03.

### (a6) When the Headlight of the Rearward Vehicle V03 Blinks (Headlight Flashing)

The approach determination unit 123 extracts information of the brightness of the headlight of the rearward vehicle V03 from the detection information that is input from the outside recognition unit 121. The approach determination unit 123 determines that the headlight blinks when a high brightness state and a low brightness state of the headlight of the rearward vehicle V03 are alternately repeated a predetermined number of times or more. The high brightness state is a state in which the brightness is higher than predetermined brightness. The low brightness state is a state in which the brightness is lower than predetermined brightness. The predetermined number of times is, for example, two to three times or more. A continuation time of one period that consists of the high brightness state and the low brightness state is, for example, 1 to 5 seconds.

### (a7) When the Honk of the Rearward Vehicle V03 Emits a Warning Sound

The approach determination unit 123 extracts information of the sound volume of the warning sound of the rearward vehicle V03 from the detection information that is input from the outside recognition unit 121. The approach determination unit 123 determines that the honk of the rearward vehicle V03 is emitting a warning sound when the sound volume is greater than a predetermined threshold value of the sound volume. The threshold value of the sound volume is, for example, 80 to 90 dB.

The approach determination unit 123 may determine that the rearward vehicle V03 is approaching the vehicle M when it is determined that any of the predetermined condition and the predetermined plurality of conditions of conditions (a1) to (a7) described above is satisfied and that only one of or both of the following conditions (b1) and (b2) are satisfied.

(b1) is a case where a lane on which another vehicle can travel is not present in a predetermined range in front of the travel position of the vehicle M. Examples of such a case include (b1-1) a case where the number of lanes of the road having a lane on which the vehicle M is traveling is one, (b1-2) a case where although the number of lanes of the road having a lane on which the vehicle M is traveling is two or more, another vehicle is traveling in a predetermined range in front of a rearward vehicle V03 on a lane (hereinafter, referred to as another lane) other than the lane on which the vehicle M is traveling, and the like. Both cases are situations in which the rearward vehicle V03 cannot overtake the vehicle M, and therefore, there is a high possibility that the vehicle M is subject to tailgating from the rearward vehicle V03.

When determining whether the (b1-1) condition is satisfied, the approach determination unit 123 refers to the second map information 62 and identifies a road that includes the position of the vehicle M which is recognized by the vehicle position recognition unit 122. The approach determination unit 123 determines that the (b1-1) condition is satisfied when the number of lanes in the travel direction of the vehicle M of the identified road is one.

When determining whether the (b1-2) condition is satisfied, the approach determination unit 123 refers to the second map information 62 and identifies a road that includes the position of the vehicle M which is recognized by the vehicle position recognition unit 122. The approach determination unit 123 determines whether or not the number of lanes in the travel direction of the vehicle M of the identified road is two or more. When it is determined that the number of lanes in the travel direction of the vehicle M of the identified road is two or more, the approach determination unit 123 refers to state information that is recognized by the outside recognition unit 121, and when it is further determined that another vehicle is present in a predetermined range in front of a rearward vehicle V03, for example, on a right lane of the vehicle M as another lane, it is determined that the (b1-2) condition is satisfied. The predetermined range is, for example, a distance that corresponds to 2 to 3 seconds of the vehicle head time of the rearward vehicle V03 when it is assumed that the rearward vehicle V03 changes the lane to another lane.

(b2) is a case where a lane on which the vehicle M travels is jammed. Such a case is also a situation in which the rearward vehicle V03 cannot overtake the vehicle M, and therefore, there is a high possibility that the vehicle M is subject to tailgating from the rearward vehicle V03. A case where it is determined that the (b2) condition is satisfied by the approach determination unit 123 is a case where the travel speed of the vehicle M is equal to or less than a predetermined threshold value ΔV of the travel speed, and an inter-vehicle distance D02 to a frontward vehicle V01 immediately before the vehicle M is equal to or less than a predetermined threshold value ΔD of the inter-vehicle distance. The threshold value ΔV of the travel speed is, for example, 0.6 to 0.8 times of the speed limit of the lane. The threshold value ΔD of the inter-vehicle distance is, for example, a distance that corresponds to 1 to 2 seconds of the vehicle head time at the speed limit.

### (Offset of Vehicle)

When the approach information that is input from the approach determination unit 123 indicates approach of the rearward vehicle V03 to the vehicle M, and when the detection information that is input from the outside recognition unit 121 indicates travel of a frontward vehicle V01 in front of the vehicle M, the action plan generation unit 130 causes the vehicle M to be offset. A case that indicates travel of a frontward vehicle V01 in front of the vehicle M is, more specifically, a case where a frontward vehicle V01 is present in a predetermined range δV frontward from the vehicle M in the travel lane of the vehicle M. The predetermined range δV is, for example, a distance that corresponds to 5 to 6 seconds of the vehicle head time of the vehicle M. The action plan generation unit 130 identifies a predetermined region of the frontward vehicle V01 that is arranged in the same direction as the arrangement direction of the driving position of the rearward vehicle V03 from the center of the frontward vehicle V01.

The driving position corresponds to, for example, the position of the head part of a driver seated on the driver seat. The arrangement direction of the driving position is a direction in which the driving position is arranged using the center of the vehicle as a standard. For example, the arrangement direction of the driving position of a so-called right-hand drive vehicle is the rightward direction. The action plan generation unit 130 identifies the position of a member that is arranged on the side surface of the vehicle such as a side mirror and a tail lamp as the predetermined region. The driving position of the rearward vehicle V03 may be preliminarily set in accordance with the vehicle width using the center position as a standard. Accordingly, the arrangement direction of the driving position may be set preliminarily in a predetermined direction which is, for example, a rightward direction. When the identified region on the frontward vehicle V01 is screened by the vehicle M from the driving position of the rearward vehicle V03, the action plan generation unit 130 generates a target trajectory of the vehicle M in a direction in which the identified region is exposed to the driving position of the rearward vehicle V03. The term “being exposed” means emerging without being screened, that is, being visually recognized from the position. The action plan generation unit 130 calculates the difference between a lateral coordinate of the vehicle M at that time point and a lateral coordinate of the vehicle M at which the identified region is exposed to the driving position of the rearward vehicle V03 as an offset amount DF. The action plan generation unit 130 determines an opposite direction of the arrangement direction of the driving position as the offset direction. The action plan generation unit 130 generates a target trajectory of the vehicle M such that the vehicle M is moved in the determined offset direction by the offset amount DF while moving frontward and spending a predetermined offset time. Accordingly, the direction of the target trajectory becomes a direction that diagonally intersects with the lane direction. The action plan generation unit 130 may determine the direction ϕ of the target trajectory in the offset such that the sinusoidal value sin ϕ becomes a value obtained by dividing the offset amount DF by the travel distance in the offset time.

The action plan generation unit 130 outputs the generated target trajectory to the travel control unit 141. Accordingly, the vehicle M is moved in the offset direction by the offset amount DF. Therefore, the driver of the rearward vehicle V03 can visually recognize a region of the frontward vehicle V01 and understand the travel state of the frontward vehicle V01. Thereby, it is possible to cause the driver of the rearward vehicle V03 to stop the tailgating with respect to the vehicle M. The offset direction may be the same direction as the arrangement direction of the driving position. The offset amount tends to be smaller when the offset direction is the opposite direction to the arrangement direction of the driving position compared to when the offset direction is the same direction as the arrangement direction of the driving position.

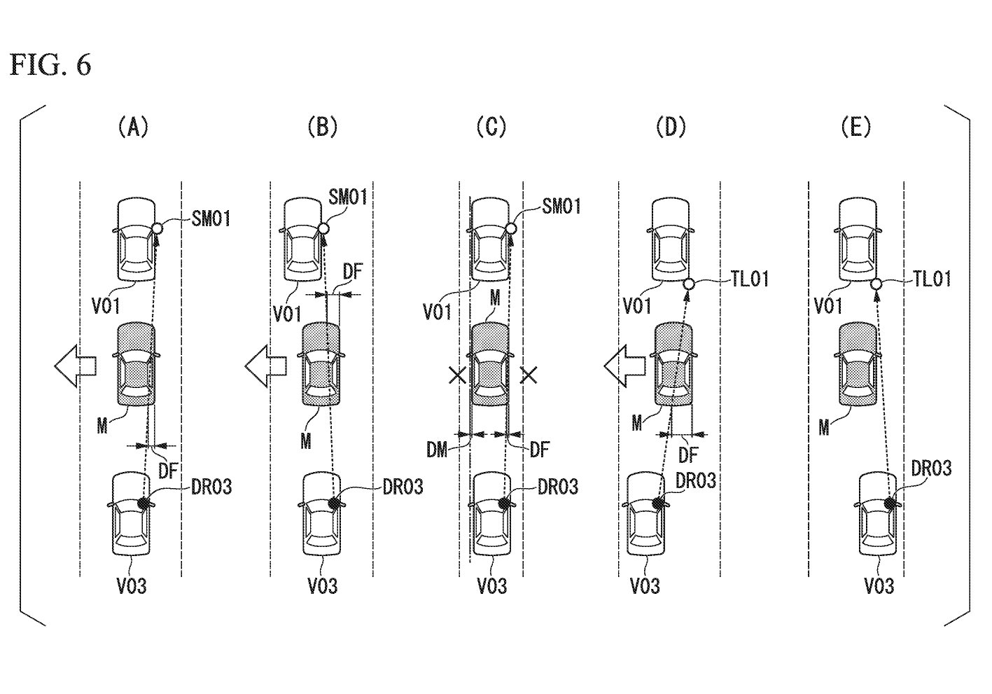

Next, an example of the offset of the vehicle M is described. FIG. 6 is a view showing an example of an offset according to the present embodiment FIG. 6 is an example in which the frontward vehicle V01, the vehicle M, and the rearward vehicle V03 travel on a predetermined lane in this order. In FIG. 6, the travel direction of each vehicle is shown in a direction that is directed toward an upper direction from a lower direction.

Part (A) of FIG. 6 shows an example of a situation in which each of the frontward vehicle V01, the vehicle M, and the rearward vehicle V03 is traveling on a middle portion of a lane. A reference numeral SM01 indicates the position of a side mirror (right) of the frontward vehicle V01. A reference numeral DR03 indicates the driving position of the rearward vehicle V03. In this situation, the side mirror SM01 of the frontward vehicle V01 is deviated more rightward than the driving position DR03 of the rearward vehicle V03. The action plan generation unit 130 determines a distance which is equal to or more than a distance between a right rear end of the vehicle M and an intersection point of a rear end of the vehicle M with a line segment that connects the driving position DR03 of the rearward vehicle V03 and the side mirror SM01 of the frontward vehicle V01 as the offset amount DF. The action plan generation unit 130 determines a target trajectory of the vehicle M such that the vehicle M is displaced by the offset amount DF.

Part (B) of FIG. 6 shows an example of a situation in which the frontward vehicle V01 is traveling on a left portion of a lane, and the vehicle M and the rearward vehicle V03 are traveling on a middle portion of the lane. In this situation, the side mirror SM01 of the frontward vehicle V01 is deviated more leftward than the driving position DR03 of the rearward vehicle V03. The action plan generation unit 130 determines a distance which is equal to or more than a distance between a right front end of the vehicle M and an intersection point of a front end of the vehicle M with a line segment that connects the driving position DR03 of the rearward vehicle V03 and the side mirror SM01 of the frontward vehicle V01 as the offset amount DF. As shown in part (A) and part (B) of FIG. 6, when determining the offset amount DF, the action plan generation unit 130 determines whether the positions of the rear end and the rear right end of the vehicle M are referred to or the positions of the front end and the right front end of the vehicle M are referred to depending on whether the side mirror SM01 of the frontward vehicle V01 is deviated more leftward or is deviated more rightward with respect to the travel direction than the driving position DR03 of the rearward vehicle V03. In order to identify the positions of the rear end, the rear right end, the front end, and the right front end of the vehicle M, a vehicle width and a vehicle length of the vehicle M are preliminarily set in the action plan generation unit 130.

Part (C) of FIG. 6 shows an example of a situation in which each of the frontward vehicle V01, the vehicle M, and the rearward vehicle V03 is traveling on a middle portion of a lane. At this time, the action plan generation unit 130 can determine the offset amount DF similarly to the example shown in part (A) of FIG. 6. However, the width of the lane is narrower than those of the examples shown in part (A) and part (B) of FIG. 6. Therefore, a displaceable distance DM that is obtained by subtracting a predetermined distance from a distance from the left end of the vehicle M to the left end of the lane becomes smaller than the offset amount DF. The predetermined distance corresponds to the width of a travel restriction zone, in which a vehicle is not allowed to travel, of the lane. The width of the travel restriction zone is, for example, 50 cm to 80 cm. In that case, the action plan generation unit 130 determines that the vehicle M is not offset and does not generate a target trajectory used for performing offsetting. When calculating the distance from the left end of the vehicle M to the left end of the lane, the action plan generation unit 130 refers to the width of the lane indicated by the second map information 62, the position of the vehicle M, and the width of the vehicle M.

Part (D) of FIG. 6 shows an example of a situation in which each of the frontward vehicle V01 and the vehicle M is traveling on a middle portion of a lane, and the rearward vehicle V03 is traveling at a more left position than the middle portion of the lane. A reference numeral TL01 indicates a tail lamp (right) of the frontward vehicle V01. In this situation, the tail lamp TL01 of the frontward vehicle V01 is deviated more rightward than the driving position DR03 of the rearward vehicle V03. The action plan generation unit 130 determines a distance which is equal to or more than a distance between a right rear end of the vehicle M and an intersection point of a rear end of the vehicle M with a line segment that connects the driving position DR03 of the rearward vehicle V03 and the tail lamp TL01 of the frontward vehicle V01 as the offset amount DF. The action plan generation unit 130 determines a target trajectory of the vehicle M such that the vehicle M is displaced by the offset amount DF.

There may be a case in which the tail lamp TL01 of the frontward vehicle V01 is deviated more leftward than the driving position DR03 of the rearward vehicle V03 depending on the traffic situation. In that case, the action plan generation unit 130 determines a distance which is equal to or more than a distance between a right front end of the vehicle M and an intersection point of a front end of the vehicle M with a line segment that connects the driving position DR03 of the rearward vehicle V03 and the tail lamp TL01 of the frontward vehicle V01 as the offset amount DF.

Part (E) of FIG. 6 shows an example of a situation in which each of the frontward vehicle V01 and the vehicle M is traveling on a middle portion of a lane, and the rearward vehicle V03 is traveling at a more right position than the middle portion of the lane. In this situation, the tail lamp TL01 of the frontward vehicle V01 is not screened by the vehicle M and is exposed to the driving position DR03 of the rearward vehicle V03. Therefore, the action plan generation unit 130 determines that the vehicle M is not offset and does not generate a target trajectory used for performing offsetting.

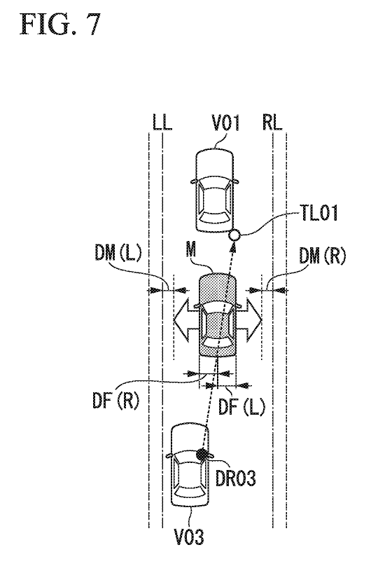

In the example shown in FIG. 6, a case in which the offset direction is fixed to the leftward direction is used as an example; however, the offset direction is not fixed to one direction and may be changed in accordance with the positional relationship among the lane width, the frontward vehicle V01, the vehicle M, and the rearward vehicle V03. In the example shown in FIG. 7, the rearward vehicle V03 can be offset such that the tail lamp TL01 is exposed to the driving position DR03 in any of the right and left directions within a range from a left limit line LL to a right limit line RL of a lane except the travel restriction zone. In that case, the action plan generation unit 130 calculates offset amounts DF(L), DF(R) that are required for the tail lamp TL01 to be exposed to the driving position of the rearward vehicle V03 with respect to each direction of the left (L) and right (R) directions. The action plan generation unit 130 determines a direction having a smaller offset amount of the calculated offset amounts DF(L), DF(R) as the offset direction. The left limit line LL indicates a right end of the travel restriction zone on the left side of the lane. The right limit line RL indicates a left end of the travel restriction zone on the right side of the lane.

The action plan generation unit 130 may further calculate a distance DM(L) from the left limit line LL to the left end of the vehicle M and a distance DM(R) from the right limit line RL to the right end of the vehicle M. In that case, the action plan generation unit 130 may determine a direction having a larger distance of the distances DM(L), DM(R) as the offset direction.

Then, the action plan generation unit 130 causes the vehicle M to be displaced in the determined offset direction such that the vehicle M is displaced by the offset amount in the offset direction.

When the left end of the vehicle M at a position where the tail lamp TL01 is exposed to the driving position of the rearward vehicle V03 by the offset to the leftward direction is at a more leftward position than the left limit line LL, the action plan generation unit 130 excludes the leftward direction from candidates of the offset direction. When the right end of the vehicle M at a position where the tail lamp TL01 is exposed to the driving position of the rearward vehicle V03 by the offset to the rightward direction is at a more rightward position than the right limit line RL, the action plan generation unit 130 excludes the rightward direction from candidates of the offset direction. The action plan generation unit 130 determines the rest of the directions which are not excluded from the candidates as the offset direction. When both of the right and left directions are excluded from the candidates of the offset direction, the action plan generation unit 130 determines that offsetting is not performed.

The action plan generation unit 130 may release offsetting when a continuation time of a state in which the approach information that is input from the approach determination unit 123 does not indicate approach of the rearward vehicle V03 to the vehicle M is longer than a predetermined continuation time. At this time, the action plan generation unit 130 may change the lateral coordinate of the middle portion of the vehicle M to a predetermined coordinate. The predetermined continuation time is, for example, 20 to 30 seconds. In that case, it is estimated that tailgating by the rearward vehicle V03 is resolved. The predetermined coordinate is a lateral coordinate of the middle portion of the travel lane. The action plan generation unit 130 generates a target trajectory of the vehicle M such that the lateral coordinate becomes the predetermined coordinate while moving frontward and spending a predetermined offset release time. The offset release time may be equal to the offset time or may be different from the offset time. When the position of the vehicle M becomes a position deviated more leftward than the middle portion of the lane by offsetting, the vehicle M is displaced in the rightward direction which is the opposite direction of the offset direction by releasing offsetting.

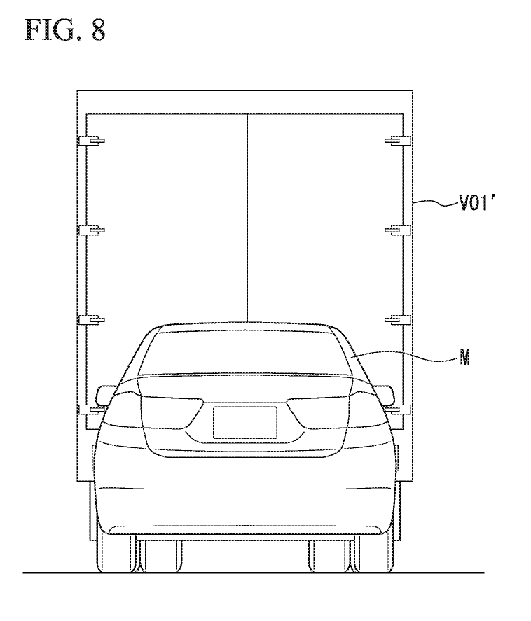

In the example shown in FIG. 6 and FIG. 7, a case in which the class of the frontward vehicle V01 is the same as that of the vehicle M, and therefore, a predetermined region of the frontward vehicle V01 is screened by the vehicle M with respect to the driver of the rearward vehicle V03 is used as an example. The predetermined region of the frontward vehicle V01 may not be screened by the vehicle M depending on the class of the frontward vehicle V01. For example, in a case where the vehicle M is a vehicle having a smaller vehicle height than a frontward vehicle V01′ such as a case in which, as shown in FIG. 8, the frontward vehicle V01′ is a vehicle having a larger vehicle height such as a truck, and the vehicle M is a regular passenger vehicle and the like, the frontward vehicle V01′ is not completely screened by the vehicle M.

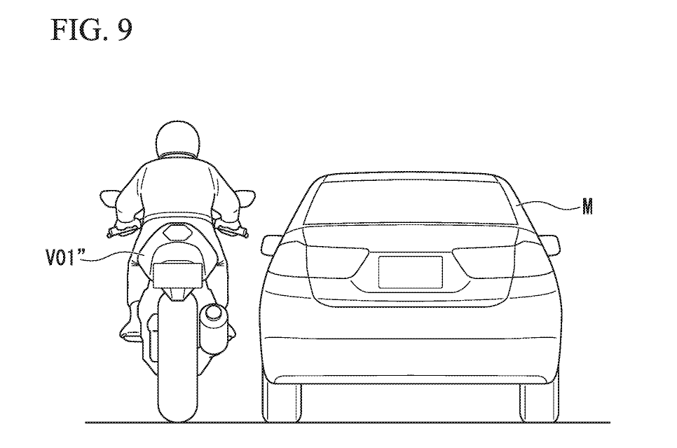

When a frontward vehicle V01″ is a two-wheel vehicle as shown in FIG. 9, the positions of the head part and the upper body part of the driver are higher than the vehicle height of the vehicle M, and therefore, the frontward vehicle V01″ is not screened by the vehicle M. Accordingly, when the action plan generation unit 130 determines that the class of the frontward vehicle V01 is a class in which a vehicle body, an accessory, an occupant, and a carrying object such as a load of the frontward vehicle V01 are not completely screened by the vehicle M from the rearward vehicle V03 based on the detection information that is input from the outside recognition unit 121, the action plan generation unit 130 may determine that the vehicle M is not offset, and a target trajectory used for offsetting is not generated.

Such a class of the frontward vehicle V01 can be different depending on the class of the vehicle M. For example, in a case where the vehicle M is a normal automobile, when the class of the frontward vehicle V01 is a truck or a two-wheel vehicle, the action plan generation unit 130 determines that the vehicle M is not offset, and a target trajectory used for offsetting is not generated. In that case, when the class of the frontward vehicle V01 is a normal automobile or a light automobile, the action plan generation unit 130 determines that the vehicle M is offset, and a target trajectory used for offsetting is generated. In a case where the vehicle M is a light automobile, when the class of the frontward vehicle V01 is a truck, a two-wheel vehicle, or a normal automobile, the action plan generation unit 130 determines that the vehicle M is not offset, and a target trajectory used for offsetting is not generated. In that case, when the class of the frontward vehicle V01 is a light automobile, the action plan generation unit 130 determines that the vehicle M is offset, and a target trajectory used for offsetting is generated. On the other hand, when the action plan generation unit 130 determines that the class of the frontward vehicle V01 is a class in which the carrying object of the frontward vehicle V01 is screened by the vehicle M, a process of offsetting with respect to the vehicle M is performed.

In FIG. 7 and FIG. 8, a case in which the class of the rearward vehicle V03 is a normal automobile similarly to the class of the vehicle M is used as an example; however, the class of the rearward vehicle V03 is not limited thereto. The action plan generation unit 130 may determine whether or not the class of the rearward vehicle V03 is a class in which a carrying object of the frontward vehicle V01 is not completely screened by the vehicle M based on the detection information that is input from the outside recognition unit 121. When it is determined that the class of the rearward vehicle V03 is a class which is not completely screened by the vehicle M, the action plan generation unit 130 determines that the vehicle M is not offset, and a target trajectory used for offsetting is not generated. When the class of the vehicle M is a normal automobile, a class which is not completely screened by the vehicle M is a truck. When the class of the vehicle M is a light automobile, a class which is not completely screened by the vehicle M is a truck or a normal automobile. When the action plan generation unit 130 determines that the class of the rearward vehicle V03 is a class in which a carrying object of the frontward vehicle V01 is screened by the vehicle M, a process of offsetting with respect to the vehicle M is performed.

When the approach information that is input from the approach determination unit 123 indicates approach of the rearward vehicle V03 to the vehicle M, and when the detection information that is input from the outside recognition unit 121 indicates travel of a frontward vehicle V01 in front of the vehicle M, the first control part 120 may output notification information that indicates approach to the vehicle M or detection of tailgating to a notification part (not shown) of the vehicle M. As the notification part, for example, a tail lamp of the vehicle M may be used. In that case, the first control part 120 causes the tail lamp to blink in accordance with a predetermined blink pattern in which lighting and extinction are alternately repeated. Alternatively, a display device that is attached to the vehicle tail part of the vehicle M may be used as the notification part. In that case, the first control part 120 causes the display device to display characters indicating a message “You are approaching too close. Please keep an inter-vehicle distance for safety.” and the like. Thereby, it is possible to prompt the driver of the rearward vehicle V03 to stop approaching to the vehicle M.

When the approach determination unit 123 determines that the condition (b2) described above is satisfied, the first control part 120 may output notification information indicating occurrence of a traffic jam in front of the vehicle M to the notification part. When the vehicle M includes the display device on the vehicle tail part, for example, the first control part 120 causes the display device to display characters indicating a message “A traffic jam is occurring.” and the like. When the condition (b2) described above is satisfied, and when the rearward vehicle V03 is approaching the vehicle M, there is a high possibility that the vehicle M is at the tail end of a vehicle group in a traffic jam or in the vicinity of the vehicle group. Therefore, the first control part 120 may cause the display device to display characters indicating a message “This is the tail end of a traffic jam.” and the like. Thereby, it is possible to prompt the driver of the rearward vehicle V03 to stop approaching to the vehicle M.

Next, a vehicle control process according to the present embodiment is described.

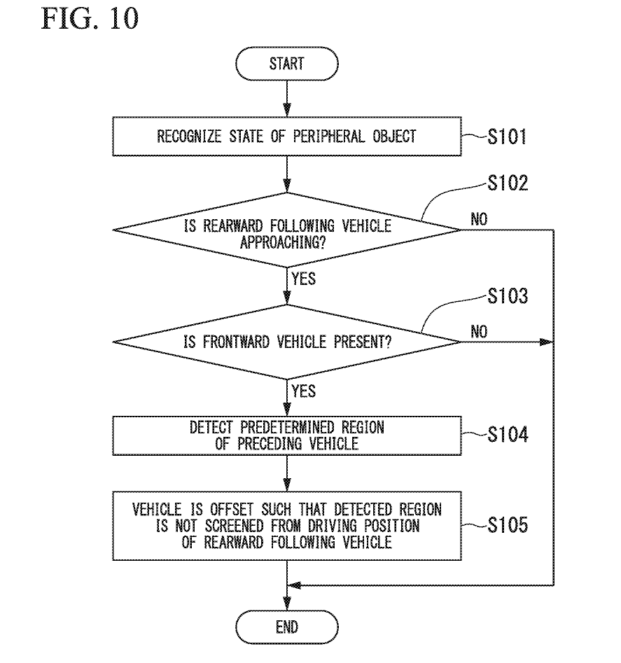

FIG. 10 is a flowchart showing a vehicle control process according to the present embodiment. A time when the first control part 120 starts the vehicle control process shown in FIG. 10 is, for example, in a predetermined period of time (for example, 20 to 30 seconds) since it is detected that the vehicle M passes through the ETC gate, a time when a traffic jam is detected in front of the vehicle M, and the like. The vehicle control process shown in FIG. 10 is repeatedly performed at a predetermined timing.

(Step S101) The outside recognition unit 121 recognizes information of a peripheral object of the vehicle M based on information that is input via the object recognition device 16. Then, the routine proceeds to a process of Step S102.

(Step S102) The approach determination unit 123 determines whether or not a rearward vehicle V03 that follows the vehicle M is approaching the vehicle M from the information that is recognized by the outside recognition unit 121. When it is determined that a rearward vehicle V03 is approaching (Step S102: YES), the routine proceeds to a process of Step S103. When it is determined that a rearward vehicle V03 is not approaching (Step S102: NO), the process shown in FIG. 10 is finished.

(Step S103) The action plan generation unit 130 determines whether or not a frontward vehicle V01 immediately before the vehicle M is present in a predetermined range from the vehicle M from the information that is recognized by the outside recognition unit 121.

When it is determined that a frontward vehicle V01 is present in a predetermined range from the vehicle M (Step S103: YES), the routine proceeds to a process of Step S104. When it is determined that a frontward vehicle V01 is not present in a predetermined range from the vehicle M (Step S103: NO), the process shown in FIG. 10 is finished.

(Step S104) The action plan generation unit 130 detects a predetermined region of the frontward vehicle V01.

Then, the routine proceeds to a process of Step S105.

(Step S105) The action plan generation unit 130 generates a target trajectory used for offsetting the vehicle M such that the detected predetermined region of the frontward vehicle V01 is not screened from the driving position of the rearward vehicle V03. The action plan generation unit 130 outputs the generated target trajectory to the travel control unit 141 and thereby causes the vehicle M to be offset. Then, the process shown in FIG. 10 is finished.

As described above, the vehicle control system according to the present embodiment includes the outside recognition unit 121, the approach determination unit 123, and the action plan generation unit 130. The outside recognition unit 121 recognizes a state of a peripheral object. The approach determination unit 123 determines based on the behavior of a rearward vehicle that is recognized by the outside recognition unit 121, approach of the rearward vehicle. The action plan generation part 130 displaces a vehicle in an intersect direction that intersects with a travel route within a travel road when the approach determination part determines that there is an approach of the rearward vehicle and when the recognition part recognizes an object in front of the vehicle.

According to this configuration, the vehicle is displaced in a direction that intersects with the travel road. Therefore, frontward circumstances of the vehicle appear to the driver of the rearward vehicle compared to when the vehicle is not displaced. It is possible to cause the driver of the rearward vehicle to understand frontward circumstances of the vehicle and thereby to ensure travel safety.

The recognition part determines approach of the rearward vehicle based on the travel speed when the rearward vehicle passes through a tollbooth gate (for example, an ETC gate). In general, a rearward vehicle having a higher travel speed when passing through a gate has a higher possibility of approaching the vehicle. Therefore, it is possible to reliably determine the approach of the rearward vehicle by a simple process.

The action plan generation part displaces the vehicle in a direction in which an object in front of the vehicle is visually recognized from the driver seat of the rearward vehicle. According to this configuration, the driver of the driving position of the rearward vehicle can find the object in front of the vehicle by the displacement of the vehicle. Therefore, it is possible to reliably cause the driver of the rearward vehicle to understand the situation in which the vehicle travels at a lower speed than the rearward vehicle and to cause the driver of the rearward vehicle to stop the abnormal approach to the vehicle.

The action plan generation part does not displace the vehicle when the distance from the end of the travel road to the end of the vehicle at a position after displacement of the vehicle at which the object is visually recognized is smaller than a predetermined distance. According to this configuration, when approach of the vehicle after displacement to a travel lane line is anticipated depending on the positional relationship between the object in front of the vehicle and the driver seat of the rearward vehicle, the vehicle is not displaced. Approach to one end of the travel road is avoided, and therefore, it is possible to maintain travel safety.

The action plan generation part displaces the vehicle in an opposite direction to the arrangement direction of the driver seat of the rearward vehicle. According to this configuration, the displacement amount of the vehicle is smaller than a case in which the vehicle is displaced in the same direction as the arrangement direction of the driver seat of the rearward vehicle. Therefore, travel safety is maintained as far as possible, and the load to the drive mechanism due to the change of the trajectory can be made small.

The object in front of the vehicle is a predetermined region of the frontward vehicle that precedes the vehicle. According to this configuration, the driver of the rearward vehicle can find the predetermined region of the frontward vehicle by the displacement of the vehicle. It is possible to cause the driver of the rearward vehicle to understand the travel state of the frontward vehicle as the situation in which the vehicle travels at a lower speed than the rearward vehicle, and therefore, it is possible to cause the driver of the rearward vehicle to stop the abnormal approach to the vehicle.

The outside recognition part determines the class of the frontward vehicle that precedes the vehicle or the class of the rearward vehicle that follows the vehicle, and the action plan generation part determines whether or not the displacement of the vehicle is required based on the class. According to this configuration, it is possible to avoid performing unnecessary displacement of the vehicle when the frontward vehicle can be visually seen from the rearward vehicle depending on the class of the frontward vehicle or the rearward vehicle.

Although an embodiment of the invention has been described with reference to the drawings, a specific configuration is not limited to those described above, and a variety of design changes and the like can be made without departing from the scope of the invention.

For example, in the embodiment described above, a case in which the action plan generation unit 130 uses the mirror and the tail lamp of the frontward vehicle as the object in front of the vehicle for a clue when determining the offset amount of the vehicle M is mainly used as the example; however, the object is not limited thereto. The object is not limited to an attachment such as the mirror and the tail lamp, a load, and the like. An installation such as a road sign of a road on which the vehicle M travels and a display object such as a road display of a travel lane on which the vehicle M travels may be used.

What is claimed is:

1. A vehicle control system, comprising:
a recognition part that recognizes a state of a peripheral object;
an approach determination part that determines, based on the behavior of a rearward vehicle recognized by the recognition part, approach of the rearward vehicle; and
an action plan generation part that displaces a vehicle in an intersect direction which intersects with a travel route within a travel road when the approach determination part determines that there is an approach and when the recognition part recognizes an object in front of the vehicle.

2. The vehicle control system according to claim 1, wherein
the action plan generation part displaces the vehicle in a direction in which the object is visually recognized from a driver seat of the rearward vehicle.

3. The vehicle control system according to claim 1, wherein
the recognition part determines approach of the rearward vehicle based on a travel speed when the rearward vehicle passes through a tollbooth gate.

4. The vehicle control system according to claim 1, wherein
the action plan generation part does not displace the vehicle when a distance from an end of a travel road to an end of the vehicle at a position after displacement of the vehicle at which the object is visually recognized is smaller than a predetermined distance.

5. The vehicle control system according to claim 3, wherein
the action plan generation part displaces the vehicle in an opposite direction to an arrangement direction of a driver seat of the rearward vehicle.

6. The vehicle control system according to claim 5, wherein
the object is a predetermined region of a frontward vehicle that precedes the vehicle.

7. The vehicle control system according to claim 6, wherein
the recognition part determines a class of the frontward vehicle or a class of the rearward vehicle, and
the action plan generation part determines whether or not the displacement is required based on the class.

8. A vehicle control method, by way of a computer, comprising:
recognizing a state of a peripheral object;
determining, based on a recognized behavior of a rearward vehicle, approach of the rearward vehicle; and
displacing a vehicle in an intersect direction that intersects with a travel route within a travel road when it is determined that there is an approach and when an object is recognized in front of the vehicle.

9. A non-transitory computer-readable recording medium comprising a vehicle control program that causes a computer to:
recognize a state of a peripheral object;
determine, based on a recognized behavior of a rearward vehicle, approach of the rearward vehicle; and
displace a vehicle in an intersect direction that intersects with a travel route within a travel road when it is determined that there is an approach and when an object is recognized in front of the vehicle.
